(19) United States
(12) Patent Application Publication
(10) Pub. No.: US 2004/0040624 A1
(43) Pub. Date: Mar. 4, 2004

(54) Method of measuring the filling degree of filling in a debarking drum

(76) Inventor: Ari Havu, Pori (FI)

Correspondence Address: BURNS DOANE SWECKER & MATHIS L L P, POST OFFICE BOX 1404, ALEXANDRIA, VA, 22313-1404, US

(21) Appl. No.: 10/432,245

(22) PCT Filed: Dec. 4, 2000
(86) PCT No.: PCT/FI00/01066

(51) Int. Cl. B27L 1/00; B27L 3/00; B27B 1/00; B23Q 15/00; B23Q 16/00

(52) U.S. Cl. 144/340; 144/356; 144/208.9

(57) ABSTRACT

A method of measuring amount of wood (13) in a rotating barking drum (1). By means of a transducer (11), the distance of the level of the wood bed (13) in the drum is measured through an opening or openings (7) of the drum.

This invention relates to a method of measuring the quantity of wood in a barking drum.

In the pulp and paper industry, the pulp wood is debarked prior to chipping. This is due to the inferior fibre yield of the bark, increased consumption of chemicals caused by the bark and, in addition, the fact that the bark causes difficulties with impurities and extractive matter in the pulp.

Cylindrical barking drums are commonly used for debarking. Logs are fed to the drum from its one end. Rotation of the drum causes motion of the logs, whereby they rub against each other and the bark on their surface is detached. The drum is slightly inclined longitudinally, causing the logs to move towards the discharge end of the drum during debarking, and leave the drum free debarked. The bark loosened from the logs is discharged from the drum through oblong bark discharge openings in the drum housing.

The bonding strength between the log and the bark varies, among other things, according to the sort of wood, season, and wood humidity. Therefore it is necessary to adjust the barking time of the logs, i.e. the retention time of the logs in the drum. The barking time can be controlled by means of a gate at the discharge end of the drum. The gate position affects the degree of filling of the drum, and the debarking time is directly proportional to the degree of filling. If the debarking time is too short, the logs remain partly unbarked, and too long a debarking time will result in wood losses due to over-barking.

Traditionally, the degree of filling of the drum has been estimated visually by estimating the height of the log bed. In long drums it is difficult to estimate the filling degree of the front end of the drum, so that the observation will be made only at the discharge end. In wintertime, the water vapour inside the drum also prevents visibility. The accuracy of the visual evaluation also depends on the operator.

Since the eighties, different types of measuring methods have been used, all of them based on measuring the weight of the drum and the wood it contains. The measurement is complicated by the fact that the drum itself is about twice as heavy as the logs in a half-filled drum. One known method is based on the use of strain-gauge transducers in the bearing constructions of the drum. The gauges measure the forces acting on the support structures. The gauge transmits an electric signal which can be converted to reflect the amount of logs in the drum. Weight measurement by means of the drum support structures has been disclosed in publication WO 91/17030.

It has been observed in practice that it is very difficult to obtain reliable weight information, particularly when strain gauges are used. The stress conditions of the support structures are affected, among other things, by changes in temperature, which for their part disturb the measurement. In order to enable fairly reliable measurements, the support structures must be designed so that all or the most part of the supporting forces are directed to a metal part provided with strain gauges. This type of construction is relatively expensive.

In hydrostatically supported drums, pressure differences in the supporting fluid for different wood loads are utilised for measuring the drum weight. This method is naturally not suitable for other types of drum support constructions.

In patent publication FI 89336, weight measurement based on the vertical movement of the drum is disclosed. This is possible only with rubber-wheel supported drums, where the pneumatic rubber wheels flex slightly under the increasing weight as the amount of wood is increased.

The characteristics of the method according to the present invention are set forth in claim 1. In the method according to the invention, the amount of wood in the drum is measured based on the level of the wood bed in the drum. According to the method, a transducer suitable for measuring the level is used, and it is positioned so that it measures the distance of the wood bed level from the transducer through bark openings or corresponding openings of the drum housing.

The invention and the details thereof are described in more detail in the following, with reference to the enclosed drawings, wherein

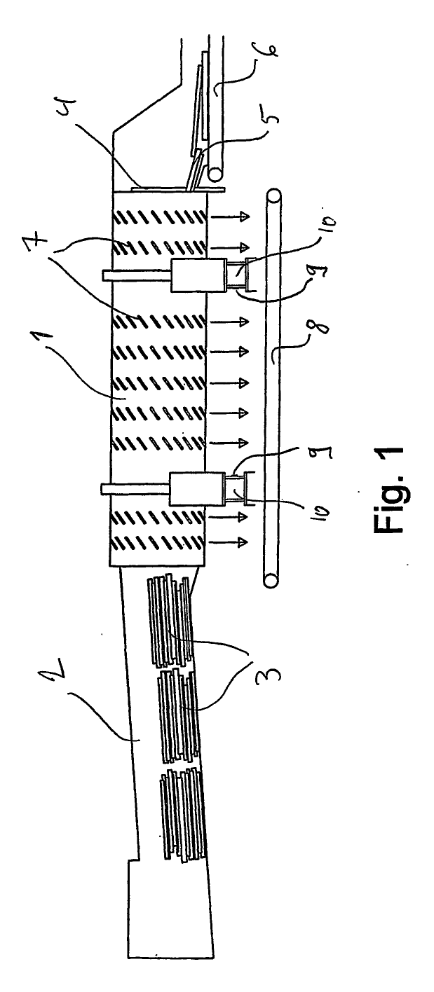

FIG. 1 shows a side view of a barking drum,

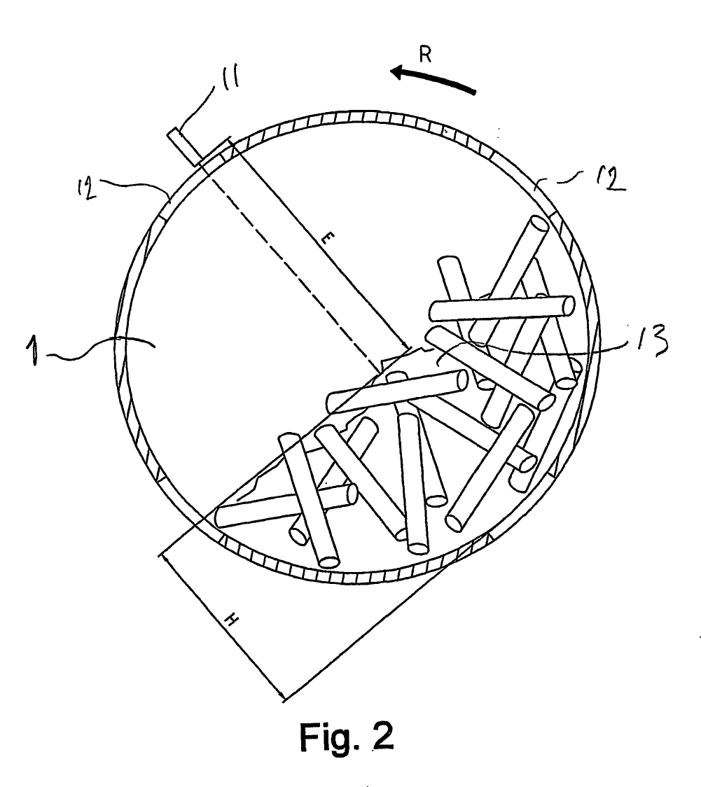

FIG. 2 shows a cross-sectional view of the drum and the measuring method in accordance with the invention.

In FIG. 1, the feeding conveyor 2 of the drum 1 feeds the logs 3 to the drum. The drum rotates 4-10 r/min, whereby the logs, due to the rotation and a small inclination of the drum, advance in the drum towards the discharge end of the drum. By means of a gate 4 in the discharge end of the drum, the amount of logs in the drum, in other words the filling degree of the drum, is adjusted. The barked logs 5 drop over the edge of the gate to the discharge conveyor 6 of the drum. The bark is discharged through openings 7 in the drum housing to the bark conveyor 8 beneath the drum 1.

Bark openings 7 that are 4-5 cm wide and about 40 cm long are usually arranged longitudinally or diagonally. In FIG. 1 the bark openings are arranged diagonally. Vertical openings are normally not used, because they lower the strength of the drum housing.

Measuring methods of the filling degree used to date are based on observing the changes caused by increase in drum weight. Strain gauges 9 that register changes in the support structures caused by weight changes are placed in supporting steel structures 10 of the drum (FIG. 1). The support structure and the gauge positions therein must be very carefully designed. Yet, the measuring signal is often inconsistent.

In the method according to the present invention, FIG. 2 shows the location of the transducer 11 in relation to the drum 1. The direction of rotation of the drum is shown by arrow R. At the measuring point, openings 12 are provided in the drum housing. The openings can be specially made for measuring, or they can be normal bark openings. The measurement is synchronised according to the location of the measuring or bark openings 12. Transducer 11 continuously obtains a signal reflecting the distance E to the logs 13 rotating in the drum. As the level of the wood bed is non-homogenous, an average value of the measuring signal within a given period is calculated. As the location of the transducer in relation to the drum and the diameter of the drum are known, it is possible to calculate the height H of the wood bed and the filling degree of the drum from the average distance calculated with a computer.

In a one-section drum housing, the measuring openings can be located in any point of the housing. If the drum is formed by two or several sections, a slot between sections can be used for measuring the distance the measurement can also be implemented at the ends of the drum, through the feed opening or the discharge opening, whereby the measurement is carried out at a slight angle in relation to the wood beds.

As measurement transducer 11, a radar, ultrasonic, laser or corresponding other transducer can be used, capable of measuring changes of distance within a range of 1 to 6 meters.

1. A method of measuring amount of wood (13) in a rotating barking drum (1), characterised in that the distance of the level of a wood bed (13) in the drum from a transducer (11) is measured by means of said transducer, through an opening or a plurality of openings (7) in the drum.

2. A method according to claim 1, characterised in that the average value during a given time period is calculated from the measuring signal.

3. A method as defined in claim 1 or 2, characterised in that the distance of the wood bed (13) is measured through measuring openings or bark openings (7) of the drum housing, and that the measurement is synchronised to the moment when the opening (7) aligns with the measuring ray or wave transmitted by the transducer (11).

4. A method as defined in claim 1 or 2, characterized in that the distance of the wood bed (13) is measured through a slot between the blocks of a drum formed by two or a plurality of sections.

5. A method as defined in claim 1 or 2, characterized in that the distance of the wood bed (13) is measured from the ends of the drum, through the feed or discharge opening of the drum.

6. A method as defined in any of the claims from 1 to 5, characterised in that (11) a radar, ultrasonic, laser or corresponding transducer for measuring distances is used.
